(19) United States
(12) Patent Application Publication
(10) Pub. No.: US 2008/0185825 A1
(43) Pub. Date: Aug. 7, 2008

(54) Device For Triggering a Second Airbag Stage

(76) Inventors: Frank-Juergen Stuetzler, South Lyon, MI (US); Armin Koehler, Sachsenheim (DE); Hermann Schuller, Niefern-Oschelbronn (DE); Maike Moldenhauer, Waldenbuch (DE)

Correspondence Address: KENYON & KENYON LLP, ONE BROADWAY, NEW YORK, NY, 10004, US

(21) Appl. No.: 11/596,025

(22) PCT Filed: Mar. 4, 2005
(86) PCT No.: PCT/EP2005/050968

§ 371 Date: Nov. 16, 2007

(30) Foreign Application Priority Data
May 12, 2004 (DE) 102004023400.0

(51) Int. Cl. B60R 21/16

(52) U.S. Cl. 280/735

(57) ABSTRACT

A device for triggering a second airbag stage as a function of at least one occupant variable and a crash severity, the crash severity being determined as a function of an impact velocity of occupants onto the airbag. In this context, the correlation between crash severity and impact velocity is formed on the basis of a standardized (standard) occupant.

### SUMMARY OF THE INVENTION

The device of the present invention for triggering a second airbag stage has the advantage that it is possible to easily differentiate between different crash situations, thereby permitting an adapted activation of the second airbag stage after a first airbag stage. This is achieved in that the second airbag stage is determined as a function of at least one occupant variable, thus, for example, an occupant classification, and an occupant-independent crash severity (hereinafter called only crash severity). Here, the crash severity is determined in particular by determining the impact velocity of vehicle occupants onto the airbag. The basis for this is the impact velocity of a standardized, freely moving (i.e., fixed weight, fixed distance to the bag and not belted in) occupant (standard occupant).

It is particularly advantageous that the impact velocity is determined as a function of a forward displacement of the occupant and a time which starts as of the beginning of the crash. The forward displacement may be determined from the acceleration signal by double integration; or an estimated forward displacement extending into the future may be calculated by way of the Taylor series. The forward displacement is then divided by the time which has elapsed as of the crash. In this manner, it is possible to determine the instantaneous (actual) impact velocity. One advantageous variant is, for example, to assume a constant forward displacement, and to measure the time which elapses from the beginning of the crash until the occupant reaches this forward displacement. Therefore, a short time signifies a high impact velocity.

Furthermore, it is advantageous that the crash severity is additionally determined as a function of the crash type. The crash type—whether, for example, it is a hard frontal crash against a wall or a soft crash, e.g., against a deformable barrier, or an angular crash—decisively determines the crash severity, which has become apparent from many experiments. That is to say, according to the above method, the impact velocity, i.e., the crash severity, must be generated as a function of the crash type (i.e., barrier type).

Moreover, the signal from upfront sensors, thus, acceleration sensors which are situated on the radiator grill, for instance, may be used for determining the crash severity. It is thereby possible to use signals very near to the crash to determine the crash severity. It is also advantageous that the crash severity is determined by way of a characteristic curve from the estimated impact velocity. In this context, the crash type provides for the selection of the characteristic curve. With knowledge of the crash severity, in combination with the at least one occupant variable, the adapted triggering of the second airbag stage may then be carried out.

### BRIEF DESCRIPTION OF THE DRAWINGS

FIG. 1 shows a block diagram of the device according to the present invention.

FIG. 2 shows a first block diagram.

FIG. 3 shows a second block diagram.

### DETAILED DESCRIPTION

Multi-stage airbags are increasingly being used to protect vehicle occupants in a manner adapted to the specific crash situation. The adaptation is accomplished in particular as a function of occupant variables and the crash severity. According to the present invention, the crash severity is determined as a function of an impact velocity of occupants onto the airbag. The correlation between crash severity and impact velocity is ascertained on the basis of a standardized occupant. However, the impact velocity is determined as a function of a forward displacement which may be estimated by a Taylor series. To determine a velocity from the forward displacement, however, a time must also be known. For that purpose, the time is taken which has elapsed from the beginning of the crash up to the instant of the presumed impact (standardized distance to the bag).

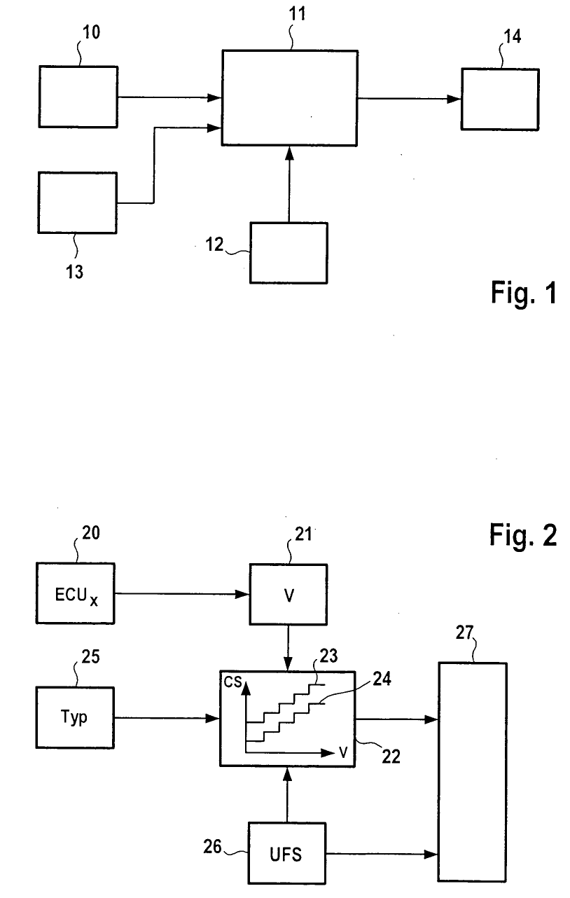

FIG. 1 shows a block diagram of the device according to the present invention. A control unit 11 for triggering restraining devices 14, which include airbags, seat-belt tensioners and roll bars, as well as pedestrian protection means, receives from an upfront sensor system 10, data from such acceleration sensors via a first data input. At the second data input, control unit 11 receives data about the surroundings from a surround-field sensor system 13. Via a third data input, control unit 11 receives data about the occupancy of the seats from an occupant sensor system 12. Occupant sensor system 12 is implemented, for example, as a multitude of weight gauge pins situated in the bracings of the respective seats. However, video, radar or ultrasonic sensor systems are possible here, as well. Control unit 11 itself has sensors which make it possible to determine an acceleration in the longitudinal direction and transverse direction of the vehicle. Plausibility sensors may also be provided in control unit 11, in addition to a microcontroller which processes all these sensor signals. In addition, plausibility circuits are also provided to permit evaluation of the sensor signals independently of the microcontroller. Watchdog functions for monitoring the microcontroller in control unit 11 are provided, as well. Control unit 11 triggers restraining devices 14 via an output.

According to the present invention, control unit 11 determines the crash severity from the sensor signals, and an occupant class from the signals of occupant sensor system 12 in order to trigger restraining devices 14 as a function of this data.

FIG. 2, in a first block diagram, shows how the crash severity is determined. In block 20, using an acceleration sensor situated in the vehicle longitudinal direction, thus in the x-direction, the acceleration is detected and integrated twice, in order to then determine from it the forward displacement, and specifically using a Taylor series. With knowledge of this forward displacement, the impact velocity of the occupant is then determined through division by the time which has elapsed from the start of the crash. This is carried out in block 21. The impact velocity is used in block 22 to determine the crash severity, and specifically by a mapping via characteristic curves. Therefore, impact velocity v is plotted on the abscissa, and crash severity CS is plotted on the ordinate. Characteristic curves 23 and 24 are selected as a function of the crash type detected. The crash type is determined in 25, and specifically by the evaluation of the acceleration signals of the acceleration sensors in control unit 11 and of upfront sensor system 10. From this, it is possible to determine whether a crash is soft or hard (further crash types and associated characteristic curves could also be necessary). In block 26, however, from upfront sensor system 10, a crash severity is likewise determined which is then ultimately fused in block 27 with the crash severity that was determined from block 22. For example, this fusion may be a weighted sum.

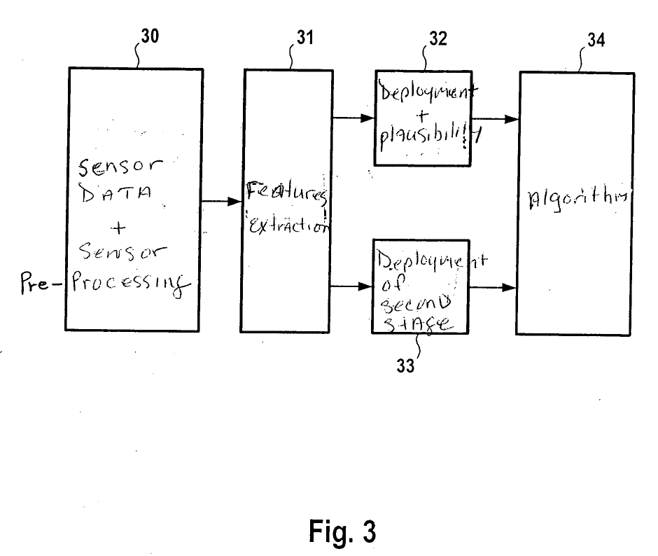

FIG. 3 clarifies the sequence which runs on the whole on the device of the present invention. In block 30, the sensor data is generated by sensors 10, 12, 13 and the sensors in control unit 11, and suitably preprocessed. In block 31, a features extraction is performed in particular by the microcontroller in control unit 11. This features extraction includes the determination as to whether it is a hard or soft crash, whether it is a false triggering or a crash, whether it is an offset crash or an angle crash, how bad the upfront severity is, and which occupant class is present. Occupant class signifies how heavy the person is and, in particular, is an airbag allowed to be triggered in this case. From this, it is then determined in block 32 whether the restraining devices should be deployed, a plausibility based on the sensor signals being determined here as well. For the plausibility, processing hardware separate from the microcontroller may be provided for the determination in control unit 11. However, the deployment of the second stage is also determined in block 33 based on the features of block 31, so that in block 34, the deployment is decided on the whole in the algorithm.

An important parameter is also when the first stage of the airbag was deployed. The algorithm then determines the optimal delay between the 1st and 2nd stage, in order to optimally adjust the pressure in the bag; alternatively, an active ventilation system may also be used for the airbag.

1-7. (canceled)

8. A device comprising:
an arrangement for determining a crash severity as a function of an impact velocity of an occupant onto an airbag; and
an arrangement for triggering a second airbag stage as a function of at least one occupant variable and the crash severity.

9. The device according to claim 8, further comprising an arrangement for determining the impact velocity as a function of a forward displacement of the occupant and a time which starts as of a beginning of the crash.

10. The device according to claim 8, wherein the crash severity is determined as a further function of a crash type.

11. The device according to claim 8, wherein the crash severity is determined as a further function of a signal from an upfront sensor system.

12. The device according to claim 8, wherein the crash severity is determined via a selectable characteristic curve as a function of the impact velocity.

13. The device according to claim 12, further comprising an arrangement for determining the characteristic curve based on a crash type.

14. A device comprising:
an arrangement for determining a crash severity as a function of an impact velocity of a standardized occupant onto an airbag; and
an arrangement for triggering a second airbag stage as a function of at least one occupant variable and the crash severity.

15. The device according to claim 14, further comprising an arrangement for determining the impact velocity as a function of a forward displacement of the occupant and a time which starts as of a beginning of the crash.

16. The device according to claim 14, wherein the crash severity is determined as a further function of a crash type.

17. The device according to claim 14, wherein the crash severity is determined as a further function of a signal from an upfront sensor system.

18. The device according to claim 14, wherein the crash severity is determined via a selectable characteristic curve as a function of the impact velocity.

19. The device according to claim 18, further comprising an arrangement for determining the characteristic curve based on a crash type.
